(19) United States
(12) Patent Application Publication
(10) Pub. No.: US 2026/0056383 A1
(43) Pub. Date: Feb. 26, 2026

(54) UNDERWATER OPTICAL FIBRE SYSTEM

(71) Applicant: Microsoft Technology Licensing, LLC, Redmond, WA (US)

(72) Inventors: Ian Dewi LANG, Romsey (GB); Raymond HORLEY, Romsey (GB); Andrew Thomas HARKER, Romsey (GB); Simon Michael BAWN, Romsey (GB); Andrew Paul APPLEYARD, Romsey (GB); Stephen NORMAN, Romsey (GB)

(73) Assignee: Microsoft Technology Licensing, LLC, Redmond, WA (US)

(21) Appl. No.: 19/102,650

(22) PCT Filed: Jul. 13, 2023
(86) PCT No.: PCT/US2023/027567

§ 371 Date: Feb. 10, 2025

(30) Foreign Application Priority Data
Aug. 11, 2022 (GB) 2211738.6

(51) Int. Cl. G02B 6/44

(52) U.S. Cl. CPC G02B 6/4427

(57) ABSTRACT

An optical fibre system comprises an optical fibre cable comprising at least one microstructured optical fibre within a jacket; and a barrier mechanism responsive to a breach of the optical fibre cable through which water from a surrounding environment of the optical fibre cable may enter voids of the microstructured optical fibre; wherein the barrier mechanism is responsive to the breach by operating to introduce a barrier across the voids of the microstructured optical fibre, the barrier configured to inhibit movement of water along the voids.

### BACKGROUND OF THE INVENTION

The present invention relates to underwater optical fibre systems.

Optical fibres are widely used for the transmission of data carried by optical signals, with multiple fibres used to carry separate data channels in parallel. For convenience and protection, the multiple fibres are commonly bundled together inside a protective outer jacket, to form an optical fibre cable. Cables are installed in a variety of environments to carry data between transmitting and receiving locations, over large and small distances. In some circumstances cables are deployed underwater, in order to carry data across oceans, seas, rivers and lakes. Undersea cables can be vulnerable to damage, included severance of the cable, caused by ships'anchors, fishing activities, seabed movement and other physical impacts and disturbances. Damage can similarly be sustained by underwater cables in non-marine environments.

Conventionally, underwater cables contain solid core optical fibres. If damage occurs, water may penetrate the interior of the cable, entering spaces between the optical fibres and between the optical fibres and the outer jacket. Protection can be provided by established techniques such as inclusion of absorbent materials or water-swellable tapes or yarns within the structure of the cable; these expand when exposed to water to form a barrier against ingress of water into the cable interior. Another approach is the inclusion of stop joints or other physical barriers which divide the cable into sections and past which water cannot travel; thereby limiting the length of the cable along which water can penetrate. Examples of such arrangements are given in U.S. Pat. Nos. 4,834,479, 4,913,517 and 5,861,575 [1, 2, 3].

More recently, optical fibres have been developed that include longitudinal voids within the internal structure of an individual fibre. These include, but are not limited to, hollow core optical fibres and fibres with microstructured cladding formed from a specified arrangement of longitudinal voids. The superior optical propagation characteristics of hollow core optical fibres compared to solid core fibres, including reduced optical loss and increased propagation speed and optical bandwidth, make them especially attractive for use in telecommunications. However, hollow core fibres are particularly at risk in the event of cable damage in an underwater environment. Entry of water into the voids in the core and cladding will negatively impact the propagation capabilities, since these depend on the voids being air- or gas-filled. The fibre therefore needs to be replaced when the damaged cable is repaired. In an undersea environment the increased water pressure at depth can force water further inside a fibre, exacerbating the problem since a greater length of fibre requires replacement.

Therefore, techniques aimed at inhibiting the ingress of water into hollow core optical fibres in optical cables are of interest.

### SUMMARY OF THE INVENTION

Aspects and embodiments are set out in the appended claims.

According to a first aspect of certain embodiments described herein, there is provided an optical fibre system comprising: an optical fibre cable comprising at least one microstructured optical fibre within a jacket; and a barrier mechanism responsive to a breach of the optical fibre cable through which water from a surrounding environment of the optical fibre cable may enter voids of the microstructured optical fibre; wherein the barrier mechanism is responsive to the breach by operating to introduce a barrier across the voids of the microstructured optical fibre, the barrier configured to inhibit movement of water along the voids.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, systems may be provided in accordance with approaches described herein which include any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a simplified schematic representation of a first example of an optical fibre cable system with a barrier mechanism as disclosed herein;

FIG. 2 shows a simplified schematic representation of a second example of an optical fibre cable system with a barrier mechanism as disclosed herein;

FIG. 3 shows a simplified schematic representation of a third example of an optical fibre cable system with a barrier mechanism as disclosed herein;

FIG. 4A shows a simplified schematic representation of a fourth example of an optical fibre cable system with a barrier mechanism as disclosed herein;

FIG. 4B shows a simplified schematic representation of the example of FIG. 4A after operation of the barrier mechanism;

FIG. 5A shows a simplified schematic representation of a fifth example of an optical fibre cable system with a barrier mechanism as disclosed herein;

FIG. 5B shows a plan view of the barrier mechanism of the example of FIG. 5A;

FIG. 6A shows a simplified schematic representation of a sixth example of an optical fibre cable system with a barrier mechanism as disclosed herein;

FIG. 6B shows a simplified schematic representation of the example of FIG. 6A after operation of the barrier mechanism;

FIG. 7A shows a simplified schematic representation of a seventh example of an optical fibre cable system with a barrier mechanism as disclosed herein; and

FIG. 7B shows a simplified schematic representation of the example of FIG. 7A after operation of the barrier mechanism.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of systems discussed herein which are not described in detail may be implemented in accordance with any conventional techniques for implementing such aspects and features.

The approaches described herein are of relevance to microstructured optical fibres, in particular hollow core optical fibres, which are discussed in more detail below, and the inclusion of such optical fibres in optical fibre cables intended for deployment under water. An optical fibre cable comprises a plurality of optical fibres arranged substantially in parallel in a bundle which is surrounded by an outer protective layer such as a jacket or sheath. The jacket may be formed, for example, from a polymer material, a low smoke zero halogen material, or stainless steel tubing. The jacket may house the optical fibres only, or in some examples other elements may be included to make the cable more robust and resistant to damage. These may include a central strength member made from a high tensile strength material such as glass reinforced plastic, fibre reinforced plastic, stranded steel, nylon or para-aramid yarn that runs the length of the cable to resist tight bending and potential damage to the optical fibres, and around which the optical fibres are arranged, bunched, wrapped, wound or twisted, and one or more buffer layers of polymer material to secure and protect individual or grouped fibres. Strength members that surround the fibres, such as in the form of a layer between the fibre bundle and the jacket, may also be used. Nevertheless, cables are still susceptible to damage, including total or partial severance of the cable, particularly when exposed to the rigours of an underwater environment.

An optical fibre cable may comprise optical fibres of any type or design, including two or more types in one cable. When an underwater cable includes hollow core or other microstructured fibres, having voids within the internal structure of the fibre, it is desirable in the event of cable damage to limit the ingress of water into the individual fibres, since the presence of water within the voids will reduce the optical performance. In a marine environment a cable may be located at considerable depth. The higher water pressure at depth can enable water to penetrate further and more rapidly from a point of damage along the individual fibres, causing distributed damage along the cable length that can extend far from the original damage site. The cable or individual fibres within the cable may be rendered inoperable, requiring significant and costly repair or replacement.

Techniques which prevent or inhibit water ingress or limit the extent of water penetration along the length of cables containing microstructured fibres with internal voids are proposed herein, which aim to minimise water-based damage and enable more localised repairs in place of replacement of substantial lengths of cable.

The term “microstructured fibres” is used herein to indicate any optical fibre that has one or more internal longitudinal voids, where the voids may define or form part of the fibre core, the fibre cladding, or both. In more detail, microstructured fibres have an internal structure comprising an array or arrangement of holes, capillaries or lumens within the fibre material, extending along the length of the fibre parallel to the longitudinal axis and defined within a material such as glass. The arrangement of holes can be termed a microstructure, and typically the microstructure forms at least part of the cladding of the fibre, and may additionally or alternatively define the core. All such structures are vulnerable to the ingress of water if the fibre is broken, for example if included within an optical fibre cable deployed underwater which experiences damage.

Microstructure configurations which define the core can provide a hollow core optical fibre, in which a cladding which is generally but not necessarily also microstructured surrounds a central hollow void or region that provides a light-guiding core. The capillaries of the microstructure are typically supported within a larger outer cladding tube made from glass. The propagation of light in air (or other gas, or a vacuum) enabled by the absence of a solid glass core reduces the proportion of a guided optical wave which propagates in glass compared to a solid core fibre, offering benefits such as increased propagation speed, reduced loss from both absorption and scattering, and reduced nonlinear interactions. Hence hollow core fibres are very attractive for telecommunications applications; they enable data transmission at nearly the speed of light in vacuum, and at higher optical powers and over broader optical bandwidths, with relative freedom from issues such as nonlinear and thermo-optic effects that can affect light travelling in solid fibres. Hollow core fibres can be categorised according to their mechanism of optical guidance into two principal classes or types: hollow core photonic bandgap fibre (HCPBF, alternatively referred to as hollow core photonic crystal fibre, HCPCF), and antiresonant hollow core fibre (AR-HCF or ARF). In HCPBF, a structured cladding region comprises a regular closely packed array of many small glass capillaries, from which a central group is excluded to define a substantially circular hollow core. The periodicity of the cladding structure provides a substantially periodically structured refractive index and hence a photonic bandgap effect that confines the propagating optical wave towards the core. In ARF, the structured cladding comprises a much lower number of larger glass capillaries or tubes with a structure lacking a high degree of periodicity so that photonic bandgap effects are not significant, but with some periodicity on a larger scale since the tubes are evenly spaced. The structure provides antiresonance for propagating wavelengths which are not resonant with a wall thickness of the cladding capillaries, where the cladding capillaries surround a central void or cavity which provides the hollow core of the fibre, and which is able to support antiresonantly-guided optical modes.

The present disclosure is applicable to all types of microstructured fibre, including the two main classes of hollow core fibre and sub-types associated therewith, plus other hollow core designs. Other examples include microstructured solid core fibres, where the structure of voids is provided in the cladding region only, around a core defined in solid material. The cladding may be an array of many capillaries to provide photonic effects, or a single ring of larger voids separated by struts of glass that support the central solid core (suspended core fibres). All other designs of optical fibre with one or more internal voids are also relevant. Note that in the art, there is some overlapping use of terminologies for the various classes of microstructured or “holey” fibres. For the purposes of the present disclosure, the term “microstructured fibre” is intended to cover all types having a longitudinal void or voids in the internal structure, and the terms “hollow core fibre” and “hollow core microstructured fibre” are intended to cover all types of these fibres having a hollow core as described above. Remarks made with particular reference to hollow core fibres are to be understood as applicable to all microstructured fibres, unless the context indicates otherwise. However, owing to the particular enhanced optical properties of hollow core optical fibres outlined above, such fibres are of significant benefit for telecommunications applications so the disclosure has particular relevance here.

It is proposed to address the problem of water ingress into the voids of hollow core and other microstructured fibres contained in optical fibre cables by providing a system including an optical fibre cable and a means, arrangement, apparatus or mechanism which is able to respond in the event of damage being caused to the cable by providing or introducing a barrier across the voids of the microstructured fibre or fibres that acts to inhibit the movement of water along the voids, so that the physical extent of damage arising from the presence of water can be reduced or limited. Inhibiting the movement of water may include blocking water ingress into the fibre interior, blocking movement of water along the voids beyond the location of the barrier, and slowing the ingress of water into the voids or flow of water along the voids. Both the physical confinement of water which has infiltrated the fibre and causing a slower spread of water within the fibre can reduce the amount of fibre or cable which has to be repaired or replaced. In particular, damage to the cable includes a breach of the cable that may also breach one or more microstructured fibres inside the cable, thereby allowing water to penetrate into the voids in the fibres. In various examples, the mechanism that provides the barrier may be operated when a breach of the cable is detected in order to emplace a barrier across the fibre's voids, and in other examples, emplacement of the barrier may be by formation of the barrier as a reaction to the presence of water entering the cable through the breach.

For simplicity, the examples will generally be described in the context of a single optical fibre, but it should be understood that the particular fibre is contained within an optical fibre cable, typically with one or more additional optical fibres, and more typically, a large plurality of additional optical fibres. The various proposed barrier mechanisms may be configured to operate on a single fibre, a group of fibres, or all fibres in the cable; it will be apparent to the skilled person where these various alternatives are most appropriate. If an individual barrier mechanism is associated with fewer than all microstructured fibres in a cable, additional barrier mechanisms may be provided at the same location in order to address all the microstructured fibres. In some arrangements, a plurality of barrier mechanisms may be provided spaced apart at intervals along the cable. This allows the cable to be “sectionalised” into separate portions for localised containment of any water than enters the fibre voids, where the barriers might be thought of as bulkheads that stop the widespread flow of water along the cable length. Where it is not otherwise apparent from the external appearance of the cable-plus-barrier mechanism system, the location(s) where a barrier or barriers are able to be provided may be made identifiable. For example, visual markers corresponding to barrier locations may be provided on the exterior of the cable jacket. In an alternative, detectable tags may be incorporated into the structure of the cable at the relevant positions, such as RFID transponders or similar elements which are detectable by use of separate detector devices. Detectable tags or other arrangements incorporated into the cable structure may be preferred as being less vulnerable to post-deployment wear and tear on the cable.

In a first group of examples, the barrier is introduced into a gap between adjacent sections or portions of the optical fibre so as to provide a barrier or bulkhead between the two portions that inhibits (reduces or prevents) the movement of water from one portion to the other portion. The barrier may be entirely watertight so as to completely block water flow, or partially watertight so as to slow or reduce the speed of water movement. For convenience, the examples are presented in terms of the adjacent portions of optical fibre being physically separate from one another, with their ends spaced apart to define the gap. The two portions of the optical fibre are optically aligned end-to-end so that light transmitted out of the end of one of the fibre portions is coupled into the adjacent end of the second fibre portion, preferably with minimal optical loss. The gap may be an empty narrow gap for free-space optical propagation between the fibre portions, or optical coupling may be facilitated by an optical arrangement between the ends of the fibre portions comprising one or more optical elements including any of lenses, mirrors, Faraday rotator materials and the like. The inclusion or not of such an optical arrangement may be selected according to requirements of accommodating a particular choice of barrier mechanism, and/or the requirements of achieving efficient coupling between the fibre types of the two portions of fibre, which may or may not be the same. Both fibre portions may be microstructured optical fibres, of the same or different configurations or designs, or one fibre portion may be microstructured optical fibre and the other fibre portion may be a solid core optical fibre. In the case where one of the fibre portions is a solid core portion, the barrier may be configured to preserve integrity of the microstructured fibre by extending into the voids to inhibit water flow along the voids from a breach location remote from the gap, rather than blocking flow between the fibre portions.

Alternatively, the adjacent portions of optical fibre may be consecutive sections of the same optical fibre, in which a slot, hole, perforation, aperture or other opening is formed to provide the gap. The opening extends generally transversely to the length of the fibre and preferably passes through all voids in the fibre microstructure so that the barrier can access and block all the voids. The sections of the fibre remain physically joined to each other by other parts of the fibre structure through which the opening does not pass, such as an outer cladding or outer jacket. Optical alignment of the adjacent portions is thereby maintained or facilitated, giving a simpler arrangement than the use of two separate portions of fibre. Herein, the term “gap” between two portions or sections of optical fibre is to be understood as covering both alternatives: a space between adjacent ends of two physically distinct and separate portions of optical fibre, or an opening into the microstructure of an optical fibre that divides the fibre into two sections which are otherwise physically continuous.

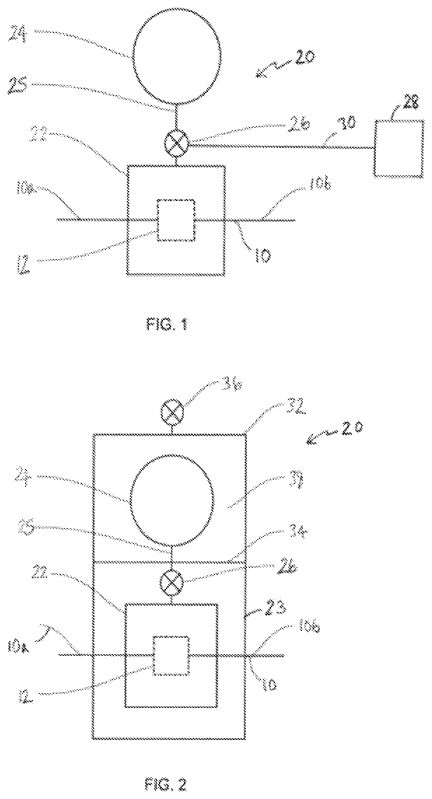

FIG. 1 shows a simplified schematic representation of an example system that utilises a gap between fibre portions, and can be used with two portions of microstructured fibre or a portion of microstructured fibre and a portion of solid core fibre. The optical fibre 10 comprises a first portion of optical fibre 10a which is a microstructured optical fibre such as a hollow core fibre, and a second portion of optical fibre 10b which may or may not be a microstructured optical fibre. The optical fibre 10 is typically bundled with other optical fibres inside an optical fibre cable (not shown), which is intended for deployment in an underwater environment, such as an undersea location. The optical fibre portions 10a, 10b are arranged sequentially end-to-end for transmission of light between the portions 10a, 10b, thereby forming the overall optical fibre 10. Other portions of optical fibre may be included beyond the depicted first and second portions, in order to extend the overall length of the optical fibre 10 and/or to accommodate additional barrier mechanisms or other optical components such as amplifiers. An optical arrangement 12 is positioned between the adjacent ends of the optical fibre portions 10a, 10b, the ends being spaced apart via a gap. The optical arrangement 12 may comprise free space, the ends of the optical fibre portions 10a, 10b being positioned (and possibly treated to reduce reflections via anti-reflection coatings or angled end facets) and aligned for propagation of light across the gap between the optical fibre portions 10a, 10b. Alternatively, optical elements may be used in the optical arrangement to improve optical coupling between the optical fibre portions 10a, 10b, such as mirrors, lenses, prisms, etc.

The barrier mechanism 20 comprises a pressure housing or pressure cell 22 which surrounds the gap/optical arrangement 12, to exclude water from the gap 12 when the cable is submerged. The first and second optical fibres portions 10a, 10b (within the cable) pass through the walls of the pressure housing 22. Also included is a reservoir 24 for supplying an inert gas, such as argon or another noble gas, nitrogen or sulphur hexafluoride (other inert gases are not excluded). In some examples, the reservoir 24 holds the inert gas already in its gaseous state. In other examples, the reservoir 24 holds a pressurised liquefied state of the gas material, which expands into the gaseous state when released from the reservoir 24. The reservoir 24 has rigid walls in order to withstand water pressure at depth and retain its shape. The reservoir 24 is in gas flow communication with the interior of the pressure housing 22, with a valve 26 (gas flow valve) arranged between the reservoir 24 and the pressure housing 22 for controlling gas flow from the reservoir 24 to the pressure housing 22. In this example, the valve 26 for the flow of gas is situated on a pipe or similar gas flow conduit 25 connecting the reservoir 24 to the pressure housing 22, but in other examples, the reservoir 24 and the pressure housing 22 might share a common wall, with an aperture in which the valve 26 is located. Under normal conditions, with the cable undamaged, the valve 26 is closed, and the reservoir 24 is filled with gas or liquefied gas, which remains in the reservoir. The valve 26 is under the control of a breach detection system 28, either via a wired or other physical connection 30, or wirelessly, depending on implementation. The breach detection system 28 is configured to detect the occurrence of damage to the cable which is likely to have caused a breach allowing water ingress, and may operate by monitoring the internal pressure in the cable or by monitoring optical signals via optical time domain reflectometry, for example. A breach will cause the internal pressure to change, so identification of a pressure change can be attributed to the occurrence of a breach (other arrangements for breach detection are possible; the functioning of the breach detection system 28 is outside the scope of this disclosure). When a breach is detected, the breach detection system 28 communicates this information to the valve 26 and the valve 26 opens to provide a gas flow path from the reservoir 24 to the pressure housing 22. Hence, the breach mechanism 20 in this example is responsive to the occurrence of a breach by allowing gas to flow from the reservoir 24 into the pressure housing 22. The gas reaches the gap between the fibre portions 10a, 10b and is able to enter the voids in the microstructures of one or both of the fibre portions 10a, 10b. If the gas is at or above the water pressure of the surrounding environment, the internal pressure within the fibre equals or exceeds the external pressure, and water cannot flow into the voids. Occupation of the voids by the gas acts as a barrier across the voids which inhibits movement along the voids of any water that has entered the voids through the breach in the cable. The gas can permeate along the voids, propelled by its higher pressure, thereby protecting a significant length of the fibre if the pressure is sufficient.

In order to achieve this with the barrier system of FIG. 1, the reservoir 24 should contain pressurised gas. Pressurisation can be implemented at the surface before underwater deployment of the cable, to an appropriate level in order to match or exceed the water pressure at the water depth to which the cable will be submerged.

In variations of this example, the gas may be delivered into the microstructured fibre voids before detection of a cable breach, either before, during or after deployment of the cable. In such an example, the breach detection system 28 is not required for operation of the barrier mechanism 20; rather the barrier is already present if a breach occurs. This can protect a longer length of the optical fibre since the pressurised gas can already be present at or near the breach site, so the amount of optical fibre along which water can penetrate from the breach is limited, or eliminated altogether. Introduction of the gas during or after deployment may require remote control of the valve 26.

In another variation, the reservoir may not be pre-filled with gas, but may contain a material or materials from which a suitable inert gas can be generated via a chemical change or reaction when required. In some examples, the material may generate the gas via decomposition, such as the decomposition of sodium azide, guanide nitrate or tetrazole (other materials are not excluded). Sufficient material may be included relative to the size of the reservoir that the gas pressure builds up to a required level. The gas may be retained in the reservoir, for release into the pressure housing via the valve in response to a detected cable breach. Alternatively, the valve may be omitted or set to be open so that the gas can disperse into the pressure housing and along the voids in the optical fibre(s) via the gap as it is generated, so as to form a barrier within the fibre(s) in advance. In the case of a chemical reaction for generating the gas, the barrier mechanism may be configured to trigger the chemical reaction in response to a detected cable breach, such as by bringing two or more materials into contact, or applying heat. As noted above, the “material” for generating the inert gas may be the liquefied form of the gas, in which case a valve is required to maintain sufficient pressure in the reservoir.

FIG. 2 shows a simplified schematic representation of another example system that utilises gas as a barrier. The system 20 includes the same elements as the system of FIG. 1, and in addition comprises a second pressure housing 32 surrounding the reservoir 24. The second pressure housing 32 is depicted as entirely surrounding both the reservoir 24 and the first pressure housing 22 around the gap/optical arrangement, the two being separated by a bulkhead 34. Alternatively, the second pressure housing 32 may be separate from the first pressure housing 22, surrounding the reservoir only. The second pressure housing 32 is provided with a second valve 36 (water flow valve) in its wall, being for the flow of water so that if opened when the system is submerged, water flows through the valve 36 to fill the interior of the second pressure housing 32. The system is deployed with the second valve 36 closed to keep water out of the second pressure housing.

The reservoir 24, in this example, is configured to be compressible (such as by being formed with walls of a flexible or deformable material, such as being a bladder), and is filled with inert gas. In the event of a breach, the breach detection system (not shown, see FIG. 1) is additionally or alternatively configured to send a signal to operate the second valve 36 to open, so that water enters the second pressure housing 32. The pressure of the admitted water compresses the reservoir 24 and forces the gas out of the reservoir 24 and into the first pressure housing 22, into the gap and into the voids in one or both portions of optical fibre 10a, 10b. The first valve 26 may be opened in conjunction with the second valve 36, or may be omitted. As a further alternative, the second valve may omitted so that the reservoir 24 is permanently exposed to the pressure of surrounding water, and gas will be gradually forced out of the reservoir and into the optical fibre portion(s) as the cable is lowered into water and the pressure increases. This allows the barrier to be in place before a cable breach occurs. Similarly, the second valve might be configured to open under the influence of increased water pressure, so that it opens automatically as the cable is submerged.

A particular feature of this configuration is its simple reversible functionality. If the water pressure reduces, in particular if the cable is raised to the surface for maintenance, repair or replacement, compression of the reservoir is reduced and the gas pressure adjusts so that it is not at a dangerous high level when the cable surfaces.

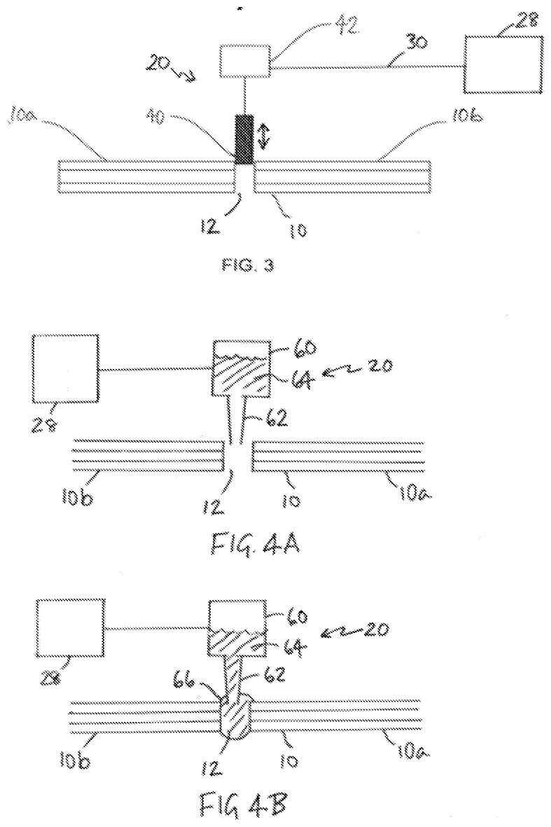

FIG. 3 shows a simplified schematic representation of a further example of an optical fibre system with a barrier mechanism. As with the previous examples, the optical fibre 10 again comprises a first portion 10a and a second portion 10b, optically aligned with their ends spaced apart by a narrow gap 12 (a space between physically separate fibre portions, or an opening in the fibre structure, as described with respect to FIG. 1) that allows optical transmission between the fibre portions 10a, 10b with preferably minimal optical loss. Both the first optical fibre portion 10a and the second optical fibre portion 10b comprise microstructured optical fibres such as hollow core optical fibres, in this example.

The barrier mechanism 20 comprises a solid gate 40 aligned with the gap 12 but transversely displaced from the optical fibre 10. The gate 40 is formed from a water-impermeable material such as metal, plastic or glass. The gate has substantially planar shape with a thickness substantially matching the length of the gap 12 in the optical fibre length direction, or thinner than the gap 12. The gate 40 is movable along the transverse direction so that it can be introduced into the gap 12 in the manner of a gate valve or a sluice valve, and cover the end of at least one of the fibre portions 10a, 10b, where it provides a barrier across the voids in the fibre portion that will inhibit (preventing or limiting) flow of water past the gate. Water cannot therefore move from one fibre portion to the other fibre portion when the gate 40 is located in the gap 12. If the gate 40 is the same thickness as the gap length 12, it will create a barrier across the voids in both fibre portions 10a, 10b when in position in the gap. If the gate 40 is thinner than the gap length 12, it can be arranged to slide closely over the end of one fibre portion 10a, 10b only, thereby forming a barrier across the voids in that fibre portion only. This will still prevent movement of water between the fibre portions 10a, 10b, thereby providing protection of whichever fibre portion 10a, 10b is on the opposite side of the gate 40 from the water entry at the cable breach location. A thinner gate 40 may be easier to move smoothly into the gap 12 than a gate 40 which is the same size as the gap 12. A pair of thinner gates 40 might be provided, each associated with the end of one fibre portion only. These could be introduced into the gap simultaneously in the event of a cable breach, or only one might be deployed, corresponding to the fibre portion in which the breach has occurred in order to contain water within that fibre portion. In any of these arrangements, the gate or gates 40 may be provided with a coating or surface layer or wrapping of a water-swellable material (not shown) that expands when exposed to water. This can enhance the sealing of the voids by the deployed gate so as to more effectively limit or prevent the movement of water between the fibre portions.

In order to locate the gate 40 when a breach occurs, the breach mechanism also comprises an actuator or drive mechanism 42 coupled to the gate 40 that operates to move the gate 40 from its start position (in FIG. 3) at the side of the gap 12 into the gap in response to a breach. Any suitable actuator or driver configured to produce mechanical movement can be used, such as a motor operating a worm drive, or an electromagnet to pull or push the gate between two positions. More passive arrangements may be preferred, such as a water-swellable material that expands and pushes on the gate 40 when exposed to water, or an expanding gas that is released to push on the gate 40 by opening a valve which may be activated by water exposure, or remotely controlled. These latter types of actuator may be simpler to implement and operate than electrical and electromagnetic options, but provide deployment of the gate only and cannot readily be reversed to retract the gate once the cable is repaired. The motion may be linear, as shown in FIG. 3, so that the gate 40 is advanced forwards into the gap, or may be rotational to swing the gate 40 into the gap. Any and all variations apparent to the skilled person are within the scope of the disclosure; the exact implementation is not significant. The actuator 42 may be under the control of the breach detection system 28 (wired via control line 30, or remotely via a suitable transceiver (not shown)), so that when a breach in the cable is detected, the barrier mechanism 20 responds in that the actuator 42 is operated to move the gate 40 to introduce it into the gap, to provide a barrier across the voids in at least one portion of the optical fibre 10a, 10b. Water-activated options can deploy the gate 40 automatically when water enters the vicinity of the breach mechanism.

An equivalent arrangement is for the actuator 42 to provide movement of one or more of the optical fibre portions 10a, 10b, rather than movement of the gate 40, in order to locate the gate 40 appropriately to form the barrier across the voids. Any arrangement providing suitable relative movement between the gate 40 and the optical fibre portions 10a, 10b can be used.

Barrier systems comprising gates may be installed at intervals along the optical fibre/optical fibre cable, and two barrier systems may be activated simultaneously in response to a breach, one on either side of the damage location so seal off a section of fibre containing the breach.

A barrier system comprising a gate can be configured for reversible operation, if the actuator is configured to provide opposite movement of the gate 40 to return it from the deployed position in the gap 12 to its rest position aligned with the gap 12. This allows the barrier system to be operated to remove the barrier from the optical fibre after a breach or damage has been repaired, thereby reinstating optical transmission along the optical fibre.

In order to maintain some optical transmission along the optical fibre after the barrier has been introduced, the gate might be formed from a material which is transparent at the wavelength(s) carried by the optical fibres in the cable, such as a suitable glass. This may allow at least some continued functionality of the optical cable after the breach, while it awaits repair.

FIG. 4A shows a simplified schematic representation of a further embodiment that utilises a gap between two portions of the optical fibre, and the active introduction of a previously external barrier into the gap in response to a cable breach. In this example, the barrier comprises a viscous fluid which is injected or otherwise directed into the gap when a cable breach is detected. By viscous, it is meant that the fluid has a higher viscosity than water, in particular sea water if the cable is deployed in a marine environment, and preferably significantly higher than the viscosity of water. Water entering the gap and meeting the viscous fluid is not easily able to mix with it or penetrate it, so movement of the water beyond the barrier is impeded and the fibre on the other side of the gap is protected from water ingress. Additionally the viscosity inhibits the viscous fluid in the gap from readily entering and moving along the voids in the fibre portions (the voids having very small widths, and the penetration time of the fluid increasing with viscosity), so that no particular damage is caused to the microstructured fibre.

As before, the system comprises an optical fibre 10 comprising a first portion 10a and a second portion 10b arranged on either side of a gap 12. The barrier mechanism 20 comprises a reservoir or container 60 holding a quantity of viscous fluid 64. The reservoir 60 has an outlet 62 aligned for fluid flow communication with the gap 12, such that viscous fluid can exit the reservoir 60 and flow into the gap 12. The outlet 62 may comprise a nozzle or outlet tube, or may simply be an opening in the reservoir wall. Depending on the configuration, the outlet 62 may be open, or may be closed by a valve or membrane that is opened when fluid delivery is required. In response to detection of a breach by the breach detection system 28, the barrier mechanism is activated to deliver a portion of the viscous fluid 64 from the reservoir 60 into the gap. Any suitable means for moving the viscous fluid 64 can be utilised. For example, a plunger arrangement may be provided that pushes viscous fluid 64 out of the reservoir 60. The reservoir 60 may be compressible or formed with flexible walls, and a mechanism may squeeze the reservoir 60 to force viscous fluid 64 out through the outlet 62. The outlet 62 may be previously closed and then opened (movement of a valve or rupturing of a membrane), and the viscous fluid 64 able to flow out under gravity or under the force of pressure of the stored viscous fluid. The reservoir 60 may comprise a simple bag or pouch, for example of plastic or plasticized foil, and a rupturing element is provided which is moved to pierce the bag to make the outlet in a suitable location for delivery of viscous fluid 64 into the gap 12. The reservoir may include a volume of pressurized or liquefied gas which is released so as to be able to expand within the reservoir and force the viscous fluid 64 out of the outlet 62.

FIG. 4B shows the system of FIG. 4A after a quantity of the viscous fluid 64 has been delivered into the gap 12. The viscous fluid 64 is able to flow to fill the gap, thereby creating the required barrier 66 across the voids of both optical fibre portions 10a, 10b. In order to better contain and direct the flow of the viscous fluid to the required location, a housing (not shown) might be provided around the gap 12, to receive the delivered viscous fluid 64.

The viscous fluid can be any fluid of an appropriate viscosity. A higher viscosity (more viscous) fluid will provide a more effective barrier, but will also cause slower flow of the viscous fluid into the gap and around the fibre ends so that the barrier forms more slowly. A balance may be struck between these aspects when selecting a viscous fluid. The viscous fluid may, for example, comprise an oil or a grease. A further example is an epoxy resin, which will set after delivery into the gap, strengthening the barrier over time. A resin may be provided by the delivery of two or more fluids which react together to form the hardenable material. However, this make a more permanent barrier which is more difficult to remove after the cable is repaired than a barrier which remains fluid. Other suitable viscous fluids include mineral oils, for example blended from alkanes, and silicone oils such as hexamethyldisiloxane or polydimethylsiloxane.

The use of a viscous fluid to form the barrier avoids the need with the gate barrier example of FIG. 3 for accurate alignment of the gate with the gap and the fibre ends. The viscous fluid simply flows in to fill the gap, conforming to the available space with only a basic alignment between the gap and the fluid source being required. Conversely, however, it provides a barrier which is not easily reversible, and which cannot be remotely retracted out of the gap when no longer needed in the way that the gate can be. Accordingly, the two arrangements have opposing benefits, and can be selected accordingly.

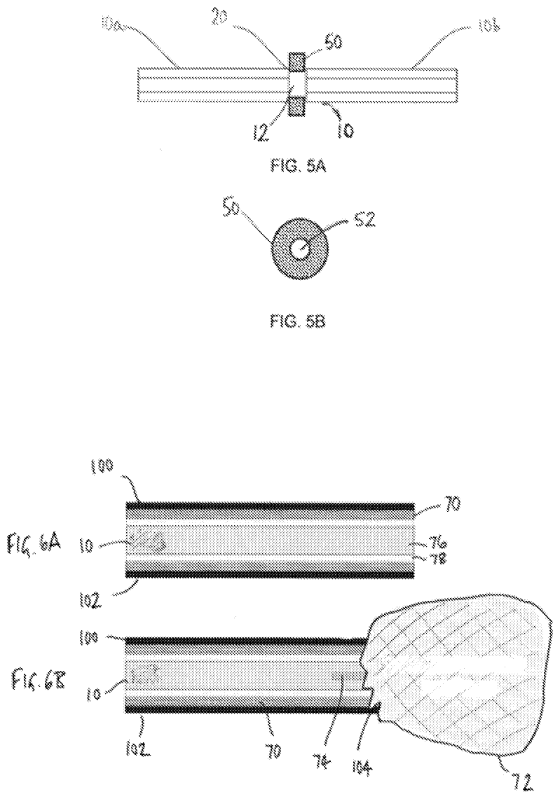

FIG. 5A shows a simplified schematic representation of another embodiment that utilises a gap between two portions of the optical fibre, arranged for optical propagation across the gap as previously described. The optical fibre 10 comprises two portions 10a, 10b of microstructured optical fibre, such as hollow core optical fibre, with a gap 12 between. The barrier mechanism 20 in this example comprises a piece, such as a plug 50 of material which may comprise a planar sheet and which is positioned in the gap. The plug 50 has a central aperture 52 which is located such that light can be transmitted through the aperture for propagation from one fibre portion 10a, 10b to the other fibre portion 10a, 10b.

FIG. 5B shows a plan view of the plug 50 with its central aperture 52. In this example, the plug 50 and the aperture 52 are circular so that the plug 50 has the appearance of a washer, the material of the sheet forming an annulus around the central aperture 52, but other shapes may be used if preferred.

The material from which the plug is formed is a water-swellable material, which has a property such that the material absorbs water to which it is exposed, and expands or swells to increase its volume in response. Examples of suitable material include superabsorbent polymers (SAP), water-swelling rubbers and water-swelling elastomers. The shape and size of the plug 50 and the aperture 52 are selected with regard to the intensity of this expansion property such that exposure to water causes sufficient swelling that the aperture nearly or completely closes (the aperture is reduced or closed), so that the plug 50 becomes continuous or near-continuous across the voids in the fibre portions 10a, 10b. An SAP may be modified with hardening agents, to create a more solid barrier, and/or with foaming agents to generate foam to additionally impede water movement.

In this example, the mechanism by which the barrier mechanism 20 operates is the expansion characteristic of the water-swellable material, such that the barrier mechanism 20 responds to a breach of the cable by producing expansion of the plug 50; this expansion provides the required barrier across the voids. In the event of a breach that allows water to enter voids in the optical fibre, water may move along one or other of the fibre portions 10a, 10b, through the voids, until it reaches the gap 12. The water can then flow out of the voids and into the gap, where it is absorbed by the water-swellable material of the plug 50, causing expansion of the plug 50 and closure of the aperture 52. Once the aperture is closed, the plug 50 forms a barrier across the voids and between the two portions of fibre 10a, 10b, inhibiting further movement of water that could enter the voids in the other fibre portion. Damage to the optical fibre is thereby limited in extent.

The plug 50 is shown in FIG. 5A as being localised to a single optical fibre 10, but may be sized to encompass several optical fibres, or indeed the whole cable in which the optical fibres are located. The plug 50 need not be in the form of a planar sheet; other shapes of material may be used as appropriate for accommodation in the gap.

This embodiment may be considered as passive, in that the breach mechanism is directly activated by the actual presence of water admitted by the breach, and does not require positive detection of the breach and subsequent activation of the breach mechanism in response to the detection. This provides considerable simplification.

It is also possible to implement a barrier in response to a breach without including a gap in the optical fibre. Some examples will now be discussed.

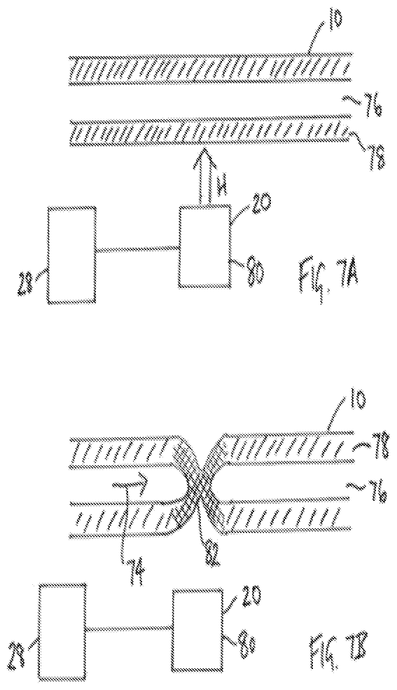

FIG. 6A shows a simplified schematic cross-sectional representation of an example of an optical fibre cable system with barrier capability that does not require any gaps in the optical fibres. The system comprises a fibre cable 100, containing at least one microstructured optical fibre 10 such as a hollow core fibre with a hollow core 76 surrounded by a microstructured cladding 78 (one fibre only is shown, for simplicity). The cable 100 comprises an outer jacket 102 surrounding the optical fibre(s) 10. The cable also includes a barrier-forming material 70, which is disposed within the outer jacket 102 around the fibre(s) 10, being added during manufacture of the cable 100. The barrier-forming material 70 comprises a viscosity modifier, being a material with a property that, when mixed with water, increases the viscosity of the water, so that the water is thickened. The ability of water to penetrate into exposed voids of the microstructured optical fibres(s) 10 depends on several parameters, including the pressure and viscosity of the water. Penetration time t is directly dependent on viscosity n according to t=((32 ηL²)/(d²p₀))tₕ (where L is the penetration depth, d is the diameter of the core (or other void) in the fibre, p₀ is the pressure of the water, and tₕ is a dimensionless constant which can be set to 0.1). Hence, if the viscosity of the water around a breach of the cable 100 can be increased, penetration of the surrounding water into the voids can be slowed, and the extent of damage to the fibre(s) 10 and the cable 100 can be limited.

FIG. 6B shows the optical fibre cable system of FIG. 6A, deployed underwater, after a breach has occurred. In this case the breach takes the form of severance of the cable 10, creating a broken end 104 at which the voids of the microstructured fibre (10) are exposed to the surrounding water. The breakage has also exposed the barrier-forming material 70, allowing it to disperse outwards into the surrounding water. The barrier-forming material 70 acts to substantially increase the viscosity of the water in the vicinity of the broken end 70, creating a localized body of water 72 with modified viscosity higher than that of the original water. The increase in viscosity means that water 74 which may penetrate into the voids of the optical fibre(s) does so much more slowly; its movement along the fibre is inhibited and the longitudinal extent of water exposure is limited. The body of water 72 with increased viscosity covers the end of the cable 100 and the fibre(s) 10 therein, and therefore acts as a barrier, blocking unthickened water beyond the body of water 72 from entering the voids. The viscosity-modifying properties of the barrier-forming material 70 can be thought of as the barrier mechanism of the optical fibre cable system in this example, which responds to a breach of the cable 100 to introduce or provide a barrier across the voids in the optical fibre(s) 10 by causing an increase of viscosity of the nearby water. A difference between this example and the other examples is that in this example the barrier is formed at the site of the breach, and hence acts to inhibit initial movement of water into the microstructured optical fibre. In the other examples the barrier is introduced at a separate location from the breach, according to the position of the barrier mechanism, so that the barrier acts to inhibit the further movement of water which has already penetrated the fibre voids, so that the water cannot move or easily move further along the fibre.

Examples of suitable viscosity modifiers are xanthan gum, which is used in the oil industry in large quantities to thicken drilling mud, methyl cellulose and other cellulose derivatives, and biomimetic compounds based on a slime which is produced by hagfish (being fish of the class Myxini and order Myxiniformes). Other viscosity modifiers can also be used as preferred; an example is super absorbent polymer.

FIG. 7A shows a simplified schematic cross-sectional representation of another example of an optical fibre cable system with barrier capability that does not require any gaps in the optical fibres. The system comprises a fibre cable (not shown), containing at least one microstructured optical fibre 10 such as a hollow core fibre with a hollow core 76 surrounded by a microstructured cladding 78 (one fibre only is shown, for simplicity). The system also comprises a heat source 80 operable to apply heat H (deliver thermal energy) to the optical fibre 10. The heat source 80 implements the barrier mechanism 20. The heat source 80 may have any convenient design, as indicated by the generic depiction in FIG. 7A. Examples include an electrical heating element, with an associated power source, in contact or near contact with the outer surface of the optical fibre 10. The heating element may be ring-shaped so as to wrap around the optical fibre 10, or may be a bar shape that delivers heat energy to one side of the optical fibre 10, or may be a plurality of heating elements dispersed over a local area of the optical fibre 10, or some other configuration that will be apparent to the skilled person. Other alternatives include an optical source such as a laser diode configured to apply one or more focussed beams of laser light to the optical fibre 10. Other heat sources may also be used as preferred. The heat may be provided by a chemical reaction, such as an exothermic reduction-oxidation (redox) reaction, for example a thermite or Goldschmidt reaction. In the event of a breach of the cable, the breach detection system 28 detects the breach as noted above, and sends an activating signal to the heat source 80.

FIG. 7B shows the optical fibre cable system of FIG. 7A after the barrier system 20 has responded to a breach by being activated via the breach detection system. In response to the breach, the heat source generates heat energy and delivers it to the optical fibre 10. The heat energy is absorbed by the material (typically glass) of the optical fibre 10, in particular the glass defining the microstructure (the glass being between the voids), and the temperature is raised to a level sufficient to soften or melt the glass. This causes the microstructure and the core of the optical fibre 10 to collapse, forming an amorphous or unstructured solid body of fused glass 82 that closes and blocks the voids in the optical fibre 10 and therefore creates a barrier to the movement of any water 74 that has entered the voids. Any such water is thereby inhibited (prevented or impeded, depending on the extent of the collapse) from moving past the location of the barrier and entering the voids on the far side of the barrier. The fibre on the “downstream” side of the barrier is thereby protected from water ingress, in the same manner as the various examples discussed above that introduce a barrier into a gap in the optical fibre. A plurality of heat sources 80 can be provided at intervals along the optical fibre so that a pair of heat sources 80 located on either side of a breach might be activated together to close off a section of the optical fibre containing the breach, and protect more remote parts of the optical fibre. An individual heat source might be arranged to act on a single fibre, a group of fibres, or all fibres in the cable, or the entire cable if the outer jacket of the cable is susceptible to heating and melting, or has thermal properties that provide a rapid transfer of heat energy through the jacket to the optical fibres within.

Some of the barrier systems described herein may be considered as “active”, since at least one element of the system is actively caused to operate in response to damage or a breach being detected. In such arrangements, direct communication from the breach detection system to the barrier system (such as in FIGS. 1 and 3) may be omitted, and instead an operator on the surface who receives a breach detection signal from the breach detection system can manually instigate operation of the barrier system in response. This requires remote control of the barrier system to be provided, via a radio transceiver or similar in the barrier system, for example, but allows human assessment to be made of the breach, such as regarding severity or location, so that the necessity or not of introducing barriers, and hence disrupting optical communications, can be determined. In other alternatives, the breach detection system may communicate with a computer system on the surface that makes an assessment (such as via an algorithm or a neural network) about the need to operate barrier mechanisms and sends operating signals to one or more barrier mechanisms of the cable as appropriate. Communication via a surface computer may also be used without any assessment stage so that activation of the breach mechanism is automatic in response to a cable breach; this may be more convenient that implementing underwater communication directly between the breach detection system and the barrier mechanism, particularly if multiple barrier mechanisms are provided along the cable length.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] U.S. Pat. No. 4,834,479
[2] U.S. Pat. No. 4,913,517
[3] U.S. Pat. No. 5,861,575

1. An optical fibre system comprising:
an optical fibre cable comprising at least one microstructured optical fibre within a jacket; and
a barrier mechanism responsive to a breach of the optical fibre cable through which water from a surrounding environment of the optical fibre cable may enter voids of the microstructured optical fibre;
wherein the barrier mechanism is responsive to the breach by operating to introduce a barrier across the voids of the microstructured optical fibre, the barrier configured to inhibit movement of water along the voids.

2. An optical fibre system according to claim 1, wherein the microstructured optical fibre is a hollow core optical fibre.

3. An optical fibre system according to claim 1, wherein the microstructured optical fibre is a first portion of optical fibre, and the optical fibre cable comprises a second portion of optical fibre optically aligned across a gap with the first portion of optical fibre for propagation of light between the first portion of optical fibre and the second portion of optical fibre;
and wherein the barrier mechanism operates to introduce the barrier by introducing the barrier into the gap.

4. An optical fibre system according to claim 3, wherein the gap comprises an opening in the microstructured optical fibre which extends transversely through the voids between the first portion of optical fibre and the second portion of optical fibre.

5. An optical fibre system according to claim 3, wherein the first portion of optical fibre and the second portion of optical fibre are physically separate from one another, the gap being a space between an end of the first portion of optical fibre and an end of the second portion of optical fibre.

6. An optical fibre system according to claim 3, wherein the second portion of optical fibre comprises microstructured optical fibre, and the barrier, when provided, inhibits movement of water between the first portion of optical fibre and the second portion of optical fibre.

7. An optical fibre system according to claim 4, wherein the barrier comprises gas and the barrier mechanism comprises:
a pressure housing surrounding the gap; and
a reservoir for delivering inert gas and in gas flow communication with the pressure housing;
wherein the barrier mechanism operates to introduce the barrier by allowing inert gas from the reservoir to flow into the pressure housing, and subsequently along the voids.

8. An optical fibre system according to claim 7, further comprising a gas flow valve for controlling gas flow from the reservoir to the pressure housing, the barrier mechanism allowing inert gas from the reservoir to flow into the pressure housing by opening the valve.

9. An optical fibre system according to claim 7, wherein the reservoir contains pressurised inert gas or one or more materials for generating the inert gas.

10. An optical fibre system according to claim 7, wherein the reservoir is compressible, and the barrier mechanism further comprises a second pressure housing surrounding the reservoir, and a water flow valve configured to allow water from the surrounding environment to enter the second pressure housing, the barrier mechanism further operating by opening the water flow valve to allow water from the surrounding environment to enter the second pressure housing and compress the reservoir, thereby forcing inert gas from the reservoir into the pressure housing and into the voids.

11. An optical fibre system according to claim 3, wherein the barrier comprises a solid gate aligned with the gap, and the barrier mechanism comprises an actuator configured to provide relative movement between the gate and the first and second portions of optical fibre, and operates to introduce the barrier by activating the actuator to cause the relative movement and locate the gate in the gap, across the voids.

12. An optical fibre system according to claim 3, wherein the barrier comprises a viscous fluid of greater viscosity than water in the surrounding environment, and the barrier mechanism comprises a reservoir for supplying the viscous fluid and in fluid flow communication with the gap, and operates to introduce the barrier by delivering the viscous fluid from the reservoir into the gap, across the voids.

13. An optical fibre system according to claim 3, wherein the barrier comprises a plug of water swellable material positioned in the gap, and having a central aperture through which light may propagate between the first portion of optical fibre and the second portion of optical fibre, and the barrier mechanism comprises an expansion characteristic of the water swellable material in response to contact with water, the barrier mechanism operating to introduce the barrier by producing expansion of the sheet of water swellable material when water is present in the gap in order to close or reduce the central aperture.

14. An optical fibre system according to claim 13, wherein the water swellable material comprises a superabsorbent polymer, a superabsorbent polymer with a hardening agent, or a superabsorbent polymer with a foaming agent.

15. An optical fibre system according to claim 1, wherein the barrier comprises a solid body of glass, and the barrier mechanism comprises a heat source configured to delivery heat energy to the microstructured optical fibre for melting glass defining the microstructure, and operates to introduce the barrier by melting the glass defining the microstructure so as to fuse the glass into a solid body that closes the voids of the microstructured optical fibre.

16. An optical fibre system according to claim 1, wherein the barrier comprises a body of water with increased viscosity, and the barrier mechanism comprises a viscosity modifier comprised within the optical fibre cable, the barrier mechanism operating to introduce the barrier by releasing the viscosity modifier through a breach in the optical fibre cable into surrounding water adjacent to the breach to increase viscosity of the water and form the barrier across voids of the microstructured optical fibre exposed by the breach.

17. An optical fibre system according to claim 16, wherein the viscosity modifier comprises xanthan gum, methyl cellulose or another cellulose derivative, or a biometric compound based on slime produced by fish of the order Myxiniformes.

18. An optical fibre system according to claim 7, wherein the barrier mechanism is responsive to the breach by being configured to be operable by a breach detection system configured to detect breaches in the optical fibre cable.

19. An optical fibre system according to claim 18, additionally comprising a breach detection system configured to detect breaches in the optical fibre cable, and to send a signal to the barrier mechanism to cause the barrier mechanism to operate to introduce the barrier across the voids of the microstructured optical fibre.

20. An optical fibre system according to claim 19, wherein the breach detection system is configured to detect breaches in the optical fibre cable by monitoring internal pressure of the optical fibre cable and identifying a change of the internal pressure as a breach.
